(19) United States
(12) Patent Application Publication
(10) Pub. No.: US 2007/0088613 A1
(43) Pub. Date: Apr. 19, 2007

(54) Method for managing a plurality of imaging supply items for an organization

(75) Inventors: Christopher A. Adkins, Lexington, KY (US); Robert M. Getler, Lexington, KY (US); Timothy L. Strunk, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/251,338

(22) Filed: Oct. 14, 2005

(51) Int. Cl. G06Q 20/00

(52) U.S. Cl. 705/21

(57) ABSTRACT

Methods for managing a plurality of imaging supply items for an organization, such as those that include associating the organization with a program, the program pertaining to the use of a plurality of imaging apparatuses in conjunction with a plurality of imaging supply items; associating an imaging apparatus with the program to yield a program specific imaging apparatus; and associating an imaging supply item with the program to yield a program specific imaging supply item.

### BACKGROUND OF THE INVENTION

1. Field of the invention.

The present invention relates to imaging and, more particularly, to a method for managing a plurality of imaging supply items for an organization.

2. Description of the related art.

Many organizations, such as companies, trade associations, charities, volunteer services, and governmental entities have users who print at their homes or remote offices using imaging supply items such as printhead cartridges, ink cartridges, and electrophotographic cartridges. It is desirable for the organization to achieve effecting pricing and support based on the collective print volumes across the associated printer base. Specifically, the organization might prefer to leverage volume pricing, standardize to reduce support costs, and keep company supplies from being used in non-company printers.

It is therefore desirable to track precisely, and without risk of fraud, the usage of each remote device. It is further desirable to have convenience, simplicity, and flexibility in obtaining a replacement supply item for these remote devices. Current offerings from printer manufacturers may achieve these objectives only through print management services for networked (directly or indirectly via a hosted PC) print devices inside the company. Typically these offerings have processes with high manual content, a significant amount of use of the customer's network, various pieces of software to maintain within the customer's environment, and primarily support more ‘intelligent’ devices, which make them impractical for managing distributed printer bases.

### SUMMARY OF THE INVENTION

The invention, in one exemplary embodiment, relates to a method for managing a plurality of imaging supply items for an organization, the plurality of imaging supply items being intended for operation in a corresponding plurality of imaging apparatuses operated by a plurality of users associated with the organization. The method includes associating the organization with a program, the program pertaining to the use of a plurality of imaging apparatuses in conjunction with a plurality of imaging supply items; associating an imaging apparatus with the program to yield a program specific imaging apparatus; and associating an imaging supply item with the program to yield a program specific imaging supply item.

The invention, in another exemplary embodiment, relates to an imaging apparatus for printing with an imaging supply item. The imaging apparatus includes a print engine configured to print using an imaging supply item; and a controller communicatively coupled to the print engine. The controller is configured to execute program instructions for associating the imaging apparatus with a program to yield a program specific imaging apparatus; and authenticating the imaging supply item. The program pertains to the use of the program specific imaging apparatus in conjunction with program specific imaging supply items. The imaging supply item is associated with the program to yield at least one of the program specific imaging supply items.

The invention, in yet another exemplary embodiment, relates to an imaging supply item. The imaging supply item includes a supply; a logic device; and a memory. The logic device and the memory are configured for associating the imaging supply item with a program to yield a program specific supply item; and authenticating the program specific supply item to thereby allow the use of the program specific supply item only in a program specific imaging apparatus for printing with the supply. The program pertains to the use of the program specific imaging apparatus in conjunction with the program specific imaging supply items.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 depicts an imaging system employed in accordance with an embodiment of the present invention.

FIG. 2 depicts an exemplary information system structure employed in conjunction with an embodiment of the present invention.

FIG. 3 is a flowchart depicting a method for managing a plurality of imaging supply items for an organization in accordance with an embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

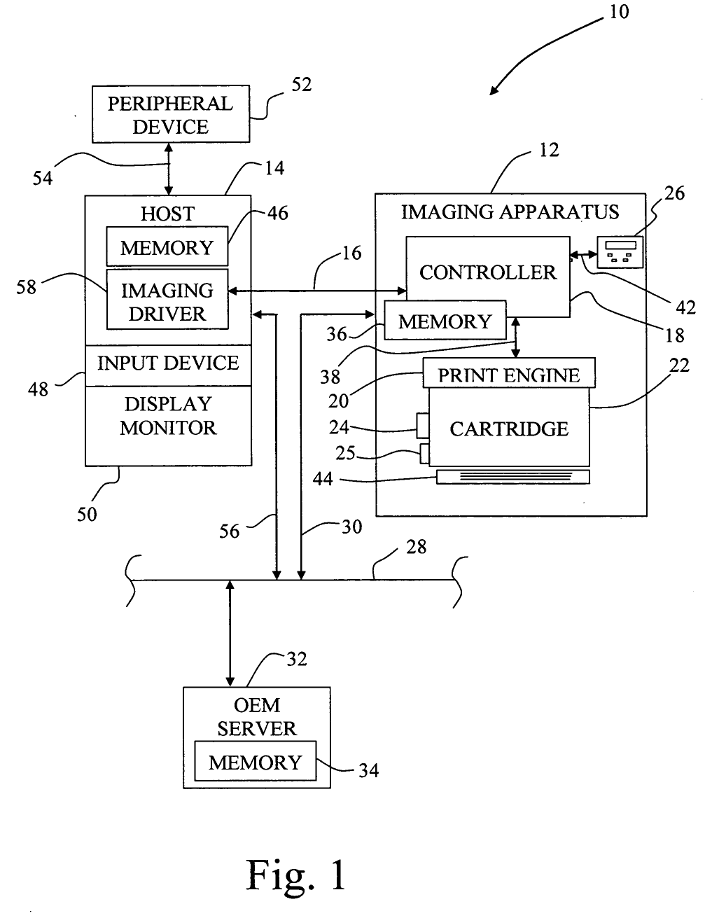

Referring now to the drawings, and particularly to FIG. 1, there is shown a diagrammatic depiction of an imaging system 10 in accordance with an embodiment of the present invention. Imaging system 10 includes an imaging apparatus 12 and a host 14. Imaging apparatus 12 communicates with host 14 via a communications link 16.

Imaging apparatus 12 may be, for example, an ink jet printer and/or copier, an electrophotographic (EP) printer and/or copier, or an all-in-one (AIO) unit that includes a printer, a scanner, and possibly a fax unit. Imaging apparatus 12 includes a controller 18, a print engine 20, a replaceable imaging supply item 22 in the form of a cartridge 22 having cartridge memory 24 and a logic device 25, and a user interface 26. Cartridge 22 may be, for example, an inkjet printhead cartridge, an ink cartridge such as an ink tank, an EP cartridge, or any consumable or user-replaceable component of imaging apparatus 12. In the form of an inkjet printhead cartridge, an ink cartridge, or an EP cartridge, cartridge 22 includes a colorant supply for printing.

Controller 18 is communicatively coupled to print engine 20, and print engine is configured to mount cartridge 22. Imaging apparatus 12 has access to a network 28, via a communication line 30, to interface with an OEM server 32 having a memory 34, in order to transmit and/or receive data for use in carrying out its imaging functions. Network 28 may be, for example, the Internet, an intranet, or any local area network (LAN) or wide area network (WAN), or a series of networks of the same or different type capable of intercommunication. In the present embodiment, OEM server 32 is a server associated with the original equipment manufacturer (OEM) of imaging apparatus 12 and/or cartridge 22. Alternatively, however, it is contemplated that OEM server 32 is, for example, a server associated with an OEM authorized component manufacturer, retailer, distributor, and/or warehouse.

Controller 18 includes a processor unit and associated memory 36, and may be formed as one or more Application Specific Integrated Circuits (ASIC). Controller 18 may be a printer controller, a scanner controller, or may be a combined printer and scanner controller, for example, such as for use in a copier. Although controller 18 is depicted as residing in imaging apparatus 12, alternatively, it is contemplated that all or a portion of controller 18 may reside in host 14. Nonetheless, as used herein, controller 18 is considered to be a part of imaging apparatus 12. Controller 18 communicates with print engine 20, cartridge 22, and cartridge memory 24 via a communications link 38, and with user interface 26 via a communications link 42. Controller 18 serves to process print data, to operate print engine 20 during printing, and to execute instructions to determine whether a cartridge 22 installed in imaging apparatus 12 is authentic.

In the context of the examples for imaging apparatus 12 given above, print engine 20 may be, for example, an ink jet print engine or an electrophotographic print engine, configured for forming an image on a substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates cartridge 22 to eject ink droplets onto substrate 44 in order to reproduce text or images, etc. As an electrophotographic print engine, print engine 26 causes cartridge 22 to deposit toner onto substrate 44, which is then fused to substrate 44 by a fuser (not shown). In the embodiment depicted, imaging apparatus 12 is an ink jet unit.

Host 14 is a computer workstation, and may be, for example, a personal computer, including memory 46, an input device 48, such as a keyboard, and a display monitor 50. One or more of a peripheral device 52, such as a digital camera, may be coupled to host 14 via communication links, such as communication link 54. Host 14 further includes a processor, input/output (I/O) interfaces, and is connected to network 28 via a communication line 56, and hence, has access to OEM server 32, including memory 34. Memory 46 may be any or all of RAM, ROM, NVRAM, or any available type of computer memory, and may include one or more of a mass data storage device, such as a floppy drive, a hard drive, a CD drive and/or a DVD drive. As set forth above, memory 36 of imaging apparatus 12 stores data pertaining to each particular cartridge 22 that has been installed in imaging apparatus 12. However, it is alternatively contemplated that memory 46 of host 14 may store such data.

During operation, host 14 includes in its memory 46 a software program including program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and host 14, and provides formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12. In any case, imaging driver 58 is considered herein as a part of imaging apparatus 12.

Cartridge memory 24 stores, among other things, usage data pertaining to the usage of cartridge 22 in an imaging apparatus, such as imaging apparatus 12. For example, controller 18 counts the number of nozzle firings during printing operations so as to track the usage of cartridge 22. The count of nozzle firings is stored in imaging apparatus 12, and a multiple of the number of nozzle firings is stored in cartridge memory 24. In the present embodiment, for example, increments of 10⁷ nozzle firings are stored in cartridge memory 24. The usage data indicates whether cartridge 22 has reached a particular usage threshold, e.g., used up its OEM installed supply of ink. Cartridge memory 24 stores other data employed in addition to usage data, including authentication data. Cartridge memory 24 is employed in conjunction with logic device 25 in accordance with the present invention for authenticating cartridge 22.

In the present embodiment, imaging apparatus 12 is an inkjet printer, and cartridge 22 is an imaging supply item in the form of a printhead cartridge having an integral ink supply.

The present invention, in an exemplary embodiment, provides, for example, a low overhead method and apparatus to offer print management services to various organizations, such as companies, corporations, trade associations, charitable and volunteer associations, and governmental entities, (referred to herein as an example of what might comprise an “organization”) with large numbers of remote (e.g. home-office) print devices. A server can be maintained by at least one of the organization, a manufacturer, distributor, and/or retailer of imaging apparatus 12 and/or cartridge 22. In one embodiment, a deal may be negotiated between the manufacturer, distributor, and/or retailer of imaging apparatus 12 and/or cartridge 22 (referred to herein as “manufacturer”) and the organization, and is referred to herein as an example of what might comprise a “program.”

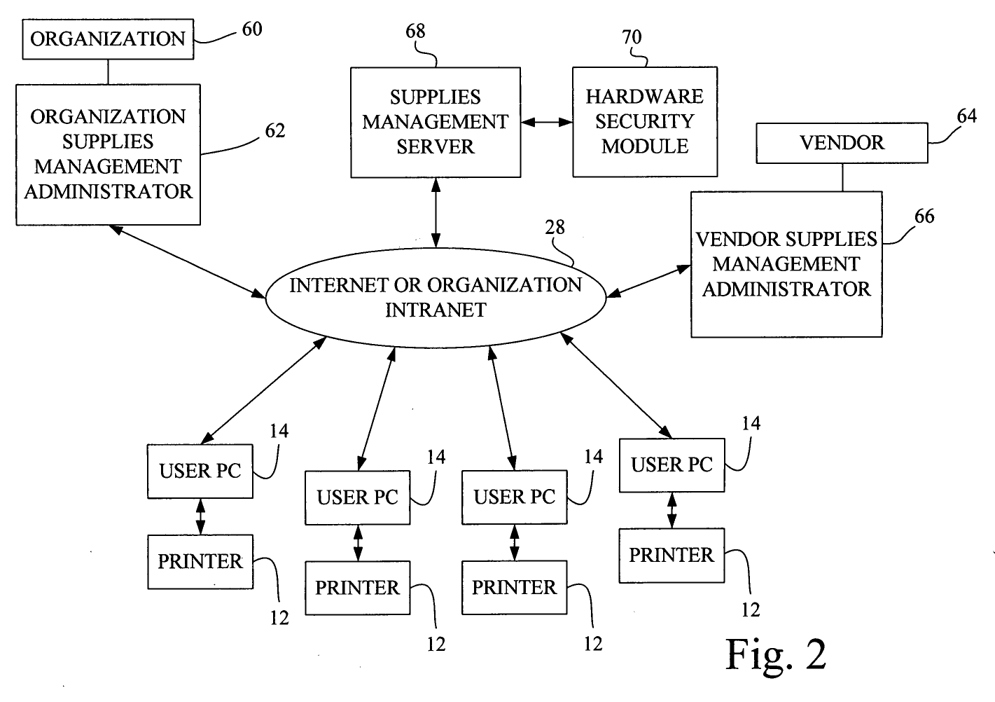

Referring now to FIG. 2, an exemplary information system structure employed in conjunction with an embodiment of the present invention is depicted. An organization 60 has users associated therewith, such as employees, volunteers, members, and the like. Each of the organization's users might employ a personal computer, such as host 14, and an imaging apparatus 12, which in the present embodiment is a printer 12, and might be connected to a network 28, such as the Internet or the organization's intranet. Many of the users work from a remote location, e.g., a home office (not shown), and hence, the users can be dispersed geographically.

A supplies management administrator 62 of the organization has access to network 28 using a conventional computer. Organization 60 might negotiate an agreement with a manufacturer, distributor, and/or retailer of imaging apparatus 12 and/or cartridge 22, referred to herein as vendor 64, to supply the organization with imaging apparatuses 12 and imaging cartridges 22, with a discounted pricing model, e.g., a volume discount pricing for imaging cartridges 22, as well as imaging apparatuses 12. A vendor supplies management administrator 66 has access to network 28 using a conventional computer. A server 68 having a hardware security module (HSM) 70 is connected to network 28. HSM 70 is employed for authenticating the use of each cartridge 22. In the present embodiment, server 68 is maintained by vendor 64. Alternatively, it is contemplated that server 68 is maintained by organization 60.

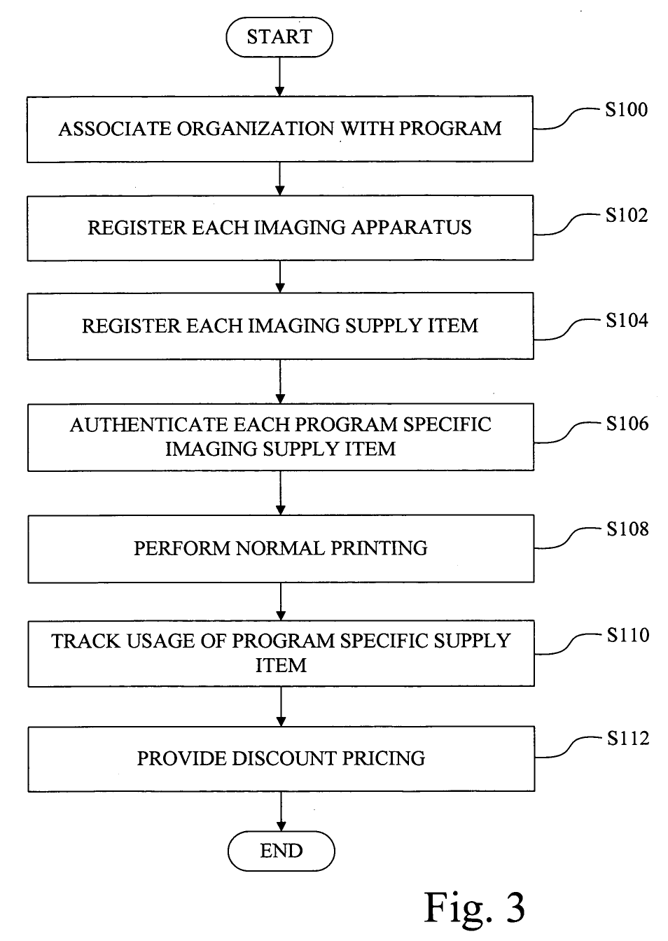

Referring now to FIG. 3, a method for managing a plurality of imaging supply items, i.e., cartridge 22, for organization 60 is generally depicted.

At step S100, organization 60 is associated with the program, which pertains to the use of a plurality of imaging apparatuses 12 in conjunction with a plurality of imaging supply items 22, such as pursuant to an agreement between organization 60 and vendor 64. The association may take the form of a business arrangement pursuant to the agreement, specifying the participation of the organization in the program, and includes the use of an identifier designated by vendor 64 as corresponding to organization 60. In order to visibly associate imaging apparatus 12 with organization 60, vendor 64 may affix the organization's logo to the imaging apparatus at the organization's request.

At step S102, each imaging apparatus 12 (printer 12) designated by organization 60 for participation in the program is associated (e.g., registered) with the program, yielding a program specific imaging apparatus 12. In the present exemplary embodiment, the association of each imaging apparatus is performed by the manufacturer of the imaging apparatus, for example, as a part of manufacturing the imaging apparatus, so as to yield said program specific imaging apparatus. Alternatively, it is considered that the association of imaging apparatus 12 may take place, for example, during regional customization of each imaging apparatus 12, or at a facility associated with organization 60, such as the office of each user for whom each corresponding imaging apparatus 12 is designated.

The present embodiment also includes the ability to securely migrate a program specific imaging apparatus 12 back to a generic imaging apparatus 12. Migration back to a generic imaging apparatus may be performed via re-manufacture of the imaging apparatus, or may be performed remotely via a secure application.

At step S104, each imaging supply item (cartridge 22) is associated (e.g., registered) with the program to yield a program specific imaging supply item. The association of cartridge 22 is based on associating the serial number of cartridge 22, stored in cartridge memory 24, with the program.

In addition to associating imaging apparatus 12 and cartridge 22 with the program, each user is associated with the program. When a particular user leaves the organization, the user may be disassociated, for example, by the organization. If an associated user no longer uses the imaging apparatus, the manufacturer may send an email inquiry to either user and/or organization so as to select a course of action desirable to the organization.

When registration is prompted though normal means, i.e. upon installation or special prompt for heavy users, an option may be given to register under an organization with instructions. This might reduce confusion if a user finds this registration path first instead of the organization-provided registration path.

At step S106, cartridge 22 is authenticated by HSM 70 via server 68 and network 28, for example, after the program specific cartridge 22 has been installed in imaging apparatus 12.

At step S108, normal printing is performed by the user.

At step S110, the usage of program specific cartridge 22 is remotely tracked by imaging apparatus 12 and by server 68 via network 28, for example, during normal printing operations. By tracking the use of program specific cartridges 22, the organization is better able to monitor the usage of its printing equipment. In addition, by tracking usage, organization 60 and/or vendor 64 are in a better position to ship replacement cartridges 22 to the user prior to exhausting the colorant supply in cartridge 22.

At step S112, when the user or the organization purchases replacement cartridges 22, vendor 64 provides discounted pricing. In the present embodiment, the discounted pricing is based on the total number of users of imaging apparatuses 12 in organization 60. Alternatively, it is considered that the discounted pricing may be based on the total actual usage of program specific cartridges 22, for example, as tracked by imaging apparatus 12 and server 68.

Set forth below are several exemplary applications of the present invention. Terms employed in the below descriptions are thusly defined:

Program printers are the program specific imaging apparatuses set forth in the embodiment of FIG. 3. Program printers are printers 12 that are manufactured to participate in the program or are modified after manufacture to participate in the program. Printers 12 that have not been manufactured or modified to be program printers may be referred to hereinafter as generic printers. Similarly, a program cartridge is a cartridge 22 that is manufactured to participate in the program or are modified after manufacture to participate in the program, whereas cartridges 22 that have not been manufactured or modified to become program cartridges may be referred to hereinafter as generic cartridges. Controller 18 of a program printer 12 is configured to recognize the intelligence built into the ink cartridge (cartridge memory 24 and logic device 25) and communicate bi-directionally with imaging driver 58.

Imaging apparatus 12 and cartridge 22 can be configured such that program cartridges 22 function only with a program printer 12 (program specific imaging apparatus 12) and/or such that a program printer 12 (program specific imaging apparatus 12) will function only with a program specific cartridge 22. More particularly, controller 18 is configured to execute program instructions for associating imaging apparatus 12 with the program and authenticating the imaging supply item, cartridge 22,. Thus, there is a reduced risk of supplies purchased by the organization being diverted to non-organization use since the program cartridges 22 will only work with program printers 12.

User registration pertains to associating the user of a program printer 12 printer with the program.

Auto Registration maintenance is a process of maintaining the user's association with the program after replacement or upgrade of host 14 or program printer 12. Thus an aspect of the present invention includes providing automatic association (e.g., registration) maintenance to associate a new printer 12 with the program when the original program printer 12 is replaced with the new printer 12. Similarly, an aspect of the present invention includes providing automatic registration maintenance to continue the registration of program printer 12 with the program when host 14 is replaced with a new host 14 or is upgraded, such as, for example, by adding or replacing a processor, memory, or operating system in host 14.

Security to authenticate cartridge 22 usage provides multiple benefits to organization 60 and vendor 64, including, such as where desired by the organization 60, keeping users from lowering program volumes by using non-OEM filled cartridges (where the lower program volumes may adversely affect the discounted pricing they receive). The authentication might also keep users from reporting false/exaggerated ink use to gain additional discounts or credits under any such programs, and facilitates the return of spent cartridges 22 from organization 60, with the appropriate credit to be provided to organization 60, such as rebates, discounts, or maintenance of pricing model as agreed to between organization 60 and vendor 64.

The various options for implementing the present invention include variations in both the method of procurement of printer 12, and the method of procurement of cartridge 22. Several possible exemplary implementations are set forth below, but these possible implementations are not intended to be inclusive. Rather, various other implementation combinations may be employed without departing from the scope of the present invention.

One possible implementation of obtaining a program printer 12 is where a remote user buys a generic printer from any source. The generic printer may be associated with the program by the user connecting to the intranet/internet and subscribing, and registering the printer 12. Unique functions to enhance the user's participation in the program could be downloaded in imaging driver 58 during registration. New printer 12 firmware could be loaded into controller 18, which transforms the generic printer into a program printer. The firmware could then be authenticated to control future unauthorized changes, such as if the same is desired by the organization. Alternatively, it is considered that the printer 12 may be electronically programmed to be a program printer once the user registers and runs a setup utility. If a discount is to be given to the organization on the printer purchase, the discount may be in the form of a rebate issued once the printer is registered and confirmed to have the proper firmware. This is the simplest option to implement in the supply chain, but also the one that either requires the most complex user registration process, or without that complexity, provides the least function.

In either case, the organization informs its users to buy a certain printer model(s) and gives registration instructions. The printer will be generic, but could have a dialog box, e.g., generated by imaging driver 58 and/or controller 18 and displayed on display monitor 50 of host 14 that specifically helps the remote user register under the appropriate organization. Upon clicking on an email registration link, the registration process will be fairly simple for the user. Upon registering, usage is authenticated and the user, organization, and the printer manufacturer will all enjoy the benefits of the agreed upon relationship. Note that the user might have the choice of not registering the printer, in which case, the user might simply remain a normal customer of the printer manufacturer.

Another possible implementation of obtaining a program printer is where the remote user buys a program printer. The program printer firmware operating as part of controller 18 will have the common functions utilized by most organizations and might be authenticated so that it may only be altered by approved entities, such as the organization's IT administrator. Downloading firmware during registration is not required, but participating retailers, if made available through retail, might need to stock two printer part numbers. The printer manufacturer optionally delivers the printer direct to either the organization or user. If fulfillment (i.e., completion of a purchase) via a retailer is the chosen distribution path, the organization might inform its users to buy a certain printer model(s), i.e., one of the program printers. To ensure that the user registers, the printer firmware might only allow printing a fixed pre-authorized number of pages before registration is required. The pages pre-authorized prior to registration might satisfy any requirement for an important job that needs to be printed immediately upon printer installation, yet ensures that registration ultimately takes place in accordance with the organization's wishes.

The program printer might have a dialog box generated by imaging driver 58 and/or controller 18 to assist the remote user in registering. In one option, no electronic registration instructions/links/programs would need to be sent to the user. A dialog box might direct the user to a generic registration site. Alternatively, it is contemplated that electronic registration instructions/links/programs may be sent to the user as so that the registration process is automatic and the wrong organization could not be accidentally chosen by the user.

In the present implementation option, authenticated firmware does not need to be loaded into controller 18 at registration. Upon registering, usage is authenticated. In addition, functions unique to a particular organization may be downloaded during registration.

An option that does not add a manufacturing part number for the program printer is for the manufacturer to include a program ship-with cartridge at final shipping assembly. When the program ship-with cartridge is installed in the printer, it tells the printer that it is now a program printer.

In yet another implementation of obtaining a program printer, the remote user may buy an organization specific printer as the program specific printer. This is the most complex to implement in the supply chain, yet the most robust registration process. During manufacturing or regional customization, the printer is programmed with an organization ID and functions particular to that organization.

To ensure that the user registers, the printer firmware might only allow printing a fixed pre-authorized number of pages before registration is required. This might satisfy any requirement for an important job that needs to be printed upon installation, yet helps ensure that registration ultimately takes place.

The program printer might have a dialog box to assist the remote user in registering. The complete registration process could be automatic other than the user provided name and address. Upon registering, usage is authenticated. The printer might have an organization ID, and thus the user would not be able to accidentally register under the wrong organization. Any updates to the agreed upon functions for each organization may be downloaded during registration.

Similar to the previous implementation set forth above, an option that does not add a manufacturing part number for the program printer is for the manufacturer to include a program ship-with cartridge at final shipping assembly. When the program ship-with cartridge is installed in the printer, it tells the printer that it is now a program printer.

Still another possible implementation of obtaining a program printer is where the remote user is provided a program printer with the printer manufacturer. Program printers are provided to the organization or its users and the organization is billed periodically based on usage.

To avoid the cost of asset tracking, it might be desirable for printer ownership to transfer to the user. Usage is authenticated for each device and then all devices are aggregated for each organization. A periodic consolidated bill may be given to the organization based on aggregate usage and the total number of printers. If a minimum level of usage does not occur, then penalty or cancellation charges may be billed to the organization. Such a system is enabled by the accurate and fraud-resistant usage authentication system described herein. The cartridges could be supplied by any option listed below.

In one possible implementation of obtaining a cartridge 22, the remote user may buy a generic new cartridge from any retailer. The cartridge part number might be the same as the printer manufacturer's generic cartridges. The agreed upon discounted pricing based on authenticated aggregate usage could be effected through a refund given to the organization from the printer manufacturer. Perhaps this refund given to the organization may serve as credit towards any dues or fees the user is obliged to pay the organization for the benefit of membership or other services rendered.

In another possible implementation of obtaining a cartridge 22, the remote user buys a program cartridge from any program retailer, i.e., a retailer that stocks program cartridges. In such an implementation, the cartridge part number associated with the program might be only offered through program retailers. The program cartridges may also be programmed to not operate in a generic printer, and may thus have a reduced purchase price, since they are already associated with a program. Alternately or in addition, refunds could be given to the organization based on the organization's authenticated aggregate usage of the cartridges.

In yet another possible implementation of obtaining a cartridge 22, the remote user buys a program cartridge from a program retailer that has exclusive rights to sell cartridges and printers for a particular program. However, it is more complex as it requires either the user indicating where the printer was purchased at registration or a unique retailer identification programmed into each printer during customization.

Programming the purchase point into the cartridge could be practical in the future as RFID (radio frequency identification) develops. For example, a pallet of printers could be given their ID as they are being loaded onto a truck to be delivered to a certain retailer.

In still another possible implementation of obtaining a cartridge 22, the remote user buys a program cartridge from the printer manufacturer. The agreed upon discount based on authenticated aggregate usage could be built into the price as cartridges are purchased.

In an additional possible implementation of obtaining a cartridge 22, the remote user is provided with a program cartridge pursuant to an agreement between the manufacturer of the cartridges and the organization. Such an implementation may be utilized when the organization wants periodic and consolidated billing for both the printers and cartridges. The cartridges could be shipped in advance to the organization or even directly to the remote user. The cartridges could be authenticated when installed in a program printer and might not operate otherwise.

In the above exemplary embodiments and implementations, the usage of a non-OEM remanufactured cartridge or a non-OEM filled cartridge may not count towards the aggregated discount.

Set forth below are two scenarios intended to illustrate some advantageous exemplary uses of the present invention. In a first scenario, a generic printer 12 and a generic cartridge 22 are purchased by a customer organization. The organization buys the manufacturer's printer and compatible replacement cartridge 22 at any retailer. The organization then registers the printer under a code designated by, for example, the manufacturer. The organization may then mail spent cartridges back to the manufacturer in a postage-paid package provided by the manufacturer, for example, enclosed in the packaging for the cartridge. The benefit to the organization may include free cartridges from the manufacturer for participating in a program, and may also include support priority with the manufacturer's help desk.

In another scenario, “Company A” is a major U.S. corporation under great financial pressure, and is looking for ways to reduce their costs even further. The procurement team of Company A realizes that they are spending a great deal of funds on home-office printing since many of their associates now work in virtual offices at home. Because the users are highly dispersed geographically, each user is purchasing printers and their supplies through a particular office supplies company. Although Company A may enjoy some broad volume discounts by purchasing from the existing office supply company, there is no standardization as far as the printers being chosen and there are no volume discounts being provided by any of the printer manufacturers.

Company A realizes there is an opportunity to: 1) gain better leverage (volume discounts) on both printers and their associated supplies; 2) keeps home employees from diverting supplies from the company printers and directing them to other home printing equipment; 3)standardize their home-office printer fleet to reduce calls to the company's IT help desk; and 4) brand all of their home-office printer fleet to remind employees they are printing at company expense.

Company A engages a printer manufacturer to offer a solution. Pursuant to an agreement, the manufacturer builds a custom Company A printer model by electronically modifying an existing All in One (AIO) unit, custom stencils the Company A printers with the Company A logo, and creates Company A specific cartridges by electronically modifying the cartridge memory 24 and logic device 25 of each cartridge 22. The cartridges thus become program cartridges that will only work if placed in a Company A program printer.

The manufacturer also creates an EDI interface to Company A's procurement system to enable the electronic ordering of either Company A printers or cartridges, electronically tracks the total number of printers and cartridges shipped, and provides Company A a price sheet demonstrating the price reduction based on the volume of printers and cartridges shipped per quarter.

Company A then modifies their procurement system to offer the program printer and supplies, notifies home users of the change and the financial drivers behind the effort, realizes a significant cost reduction in both printer and supplies costs, reduces the number of calls to the IT help desk since the printer fleet is standardized, and keeps users from using Company A supplies, e.g., cartridges 22, in non-Company A printers.

Features and benefits associated with the present invention might include the following.

Authenticated aggregate usage of cartridges 22 by remote users is applied to the benefit of an organization provides an organization with the ability to create a unique printer/ink cartridge combination in which they may pool their usage to gain volumetric discounts, reducing diversion of corporate supplies to non-corporate printers/needs.

Authentication might be used to exclude credit from usage of a non-OEM filled cartridge or a non-OEM remanufactured cartridge. The authentication technology might incorporate security/encryption to reduce misuse or fraud. Printers, their associated supplies, and communications between users and the manufacturer should be reliable and secure. In some cases, non genuine OEM cartridges may be used—however it may be desired to have them not count towards any usage credits or calculations under the program.

Usage authentication relying on PKI (public-private key security) or HMAC (hashed message authentication code) encryption/security helps to ensure that billing is accurate.

User registration might be promoted by configuring the printer to only allow a limited pre-authorized amount before registration. Printers acquired from the channel (prior to conversion to program printers, may allow a fixed number of pages or pixels to enable the end organizational user to operate prior to completing the program registration and subsequent conversion to the program. This step ensures that users may “print out of the box,” but eventually convert to use the program if the printer is a program printer.

Functions unique to the particular program may be downloaded during registration.

A program specific printer may be created through installation of a new driver or firmware during registration. During the on-line user registration process, functions to enable the encryption between the ink cartridges and the printer may be downloaded and run. Running of the code would convert a generic printer to a program printer.

The program printer “remembers” it was registered when the host computer is replaced and either a) prompts the imaging driver in the new host computer to ask user to confirm continuing registration, or b) informs the driver in the new host computer to automatically continue registration. Registration in the program thus continues past the point of replacement of a workstation or an operating system re-load.

When a registered printer (program printer) is replaced, the imaging driver either a) sets a status bit in the new printer so that it is automatically registered, or b) prompts user to ask if registration should be transferred to the new printer.

Programming a printer to become a program printer may be performed by installing a program cartridge and passing a code from the cartridge to the printer, e.g., from cartridge memory 24 to controller 18. For example, a program cartridge may hold the code for the printer to retrieve and run. Once the printer runs the code it would be converted to a program printer. Converting a generic printer to a program printer may be performed by downloading code from the web, installing via CD, or running code sent in an email.

Return of cartridges may be promoted by creating an incentive for the user to return a cartridge to the manufacturer by writing a unique association code into the cartridge when the cartridge is used by the customer, thus benefiting the environment, since the spent cartridges are not simply thrown away. The manufacturer will read the association code and provide an incentive or rebate to the organization for the return of that cartridge based upon the operability of the cartridge.

The ability for the organization to measure usage by user. The registration process associates a user (or workstation) with a specific printer and the cartridges used by the specific printer. If an organization desires, the association of cartridges to user may be data mined to determine how many cartridges each user has consumed.

The ability of the organization to dis-associate user with program. As set forth above, the present invention allow for users who are no longer associated with the organization/program to be de-registered from the program.

The ability to securely de-program a printer so it no longer enforces program rules. An authentication code may be stored in the supply item such that this code may be read and authenticated by a printer (PKI) or a server (HMAC).

A printer may be remanufactured to become a program printer or to return to being a generic printer, i.e., a printer that is not associated with a program.

The printer may be remotely reprogrammed over the web to become a program printer or to return to being a generic printer.

While this invention has been described with respect to exemplary embodiments, it will be recognized that the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for managing a plurality of imaging supply items for an organization, said plurality of imaging supply items being intended for operation in a corresponding plurality of imaging apparatuses operated by a plurality of users associated with said organization, comprising:
associating said organization with a program, said program pertaining to the use of a plurality of imaging apparatuses in conjunction with a plurality of imaging supply items;
associating an imaging apparatus with said program to yield a program specific imaging apparatus; and
associating an imaging supply item with said program to yield a program specific imaging supply item.

2. The method of claim 1, further comprising associating said user with said program.

3. The method of claim 2, further comprising disassociating a user when said user is no longer associated with said organization.

4. The method of claim 3, wherein said associating said user and said disassociating said user are performed by said organization.

5. The method of claim 1, wherein said organization has an associated logo, further comprising affixing said logo to said program specific imaging apparatus.

6. The method of claim 1, further comprising authenticating said program specific imaging supply item.

7. The method of claim 1, wherein associating an imaging supply item with the program comprises using a generic supply item with a program specific imaging apparatus.

8. The method of claim 6, further comprising configuring said program specific imaging supply item to function only with said program specific imaging apparatus.

9. The method of claim 1, wherein said imaging apparatus is one of a printer and an all-in-one unit.

10. The method of claim 1, further comprising providing automatic registration maintenance to associate a new imaging apparatus with said program when said program specific imaging apparatus is replaced with said new imaging apparatus.

11. The method of claim 1, wherein said imaging apparatus is employed in conjunction with a host computer, further comprising providing automatic registration maintenance to continue an association of said program specific imaging apparatus with said program when said host computer is replaced with a new host computer.

12. The method of claim 1, further comprising remotely tracking a usage of said program specific imaging supply item.

13. The method of claim 1, wherein said associating said imaging apparatus is performed by said manufacturer of said imaging apparatus as a part of manufacturing said imaging apparatus to yield said program specific imaging apparatus.

14. The method of claim 1, wherein said program specific imaging supply item is a printhead cartridge.

15. The method of claim 1, wherein said program specific imaging supply item is an ink tank.

16. The method of claim 1, wherein said program specific imaging supply item is an electrophotographic cartridge.

17. The method of claim 1, wherein further comprising allowing a program specific imaging apparatus to operate prior to association with the program, wherein the operation is limited prior to association with the program.

18. The method of claim 17, wherein the operation is limited prior to association with the program by at least one of a pre-authorized time, number of pages, and number of pixels.

19. An imaging apparatus for printing with an imaging supply item, comprising:
a print engine configured to print using an imaging supply item; and
a controller communicatively coupled to said print engine, said controller configured to execute program instructions for:
associating said imaging apparatus with a program to yield a program specific imaging apparatus; and
authenticating said imaging supply item,
wherein said program pertains to the use of said program specific imaging apparatus in conjunction with program specific imaging supply items; and
wherein said imaging supply item is associated with said program to yield at least one of said program specific imaging supply items.

20. An imaging supply item, comprising:
a supply;
a logic device; and
a memory,
said logic device and said memory being configured for:
associating said imaging supply item with a program to yield a program specific supply item; and
authenticating said program specific supply item to thereby allow the use of said program specific supply item only in a program specific imaging apparatus for printing with said supply,
wherein said program pertains to the use of said program specific imaging apparatus in conjunction with program specific imaging supply items.
